(19) United States
(12) Patent Application Publication
(10) Pub. No.: US 2023/0211634 A1
(43) Pub. Date: Jul. 6, 2023

(54) RUBBER MODIFIER FOR TIRE AND RUBBER COMPOSITION FOR TIRE

(71) Applicant: Harima Chemicals, lncorporated, Kakogawa-shi, Hyogo (JP)

(72) Inventors: Takeshi OGI, Tsukuba-shi, Ibaraki (JP); Katsuya MATSUYOSHI, Kakogawa-shi, Hyogo (JP); Takashi ARAMAKI, Tsukuba-shi, Ibaraki (JP); Kota NOMURA, Tsukuba-shi, Ibaraki (JP); Aki NAKATSU, Tsukuba-shi, Ibaraki (JP)

(73) Assignee: Harima Chemicals, lncorporated, Kakogawa-shi, Hyogo (JP)

(21) Appl. No.: 18/000,959

(22) PCT Filed: May 13, 2021
(86) PCT No.: PCT/JP2021/018188

§ 371 Date: Dec. 7, 2022

(30) Foreign Application Priority Data
Jun. 8, 2020 (JP) 2020-099124

(51) Int. Cl. B60C 1/00; C08L 93/04; C08K 5/3445; C08K 5/17

(52) U.S. Cl. CPC B60C 1/00; C08L 93/04; C08K 5/3445; C08K 5/17

(57) ABSTRACT

A rubber modifier for a tire includes rosins and/or terpenes and at least one kind of nitrogen-containing compound selected from the group consisting of a nitrogen-containing heterocyclic compound, a tertiary amine compound, and an amino alcohol.

### TECHNICAL FIELD

The present invention relates to a rubber modifier for a tire and a rubber composition for a tire, specifically, to a rubber modifier for a tire which is added to modify a rubber for a tire, and a rubber composition for a tire.

### BACKGROUND ART

Recently, it has been known that a rubber modifier or the like is added in order to improve various properties such as low fuel consumption, mechanical strength, and grip properties in vehicle tires or the like.

On the other hand, the low fuel consumption and the grip properties have been also known to have a trade-off relationship.

Therefore, a rubber composition capable of achieving both the low fuel consumption and the grip properties has been considered, and for example, a rubber composition containing 100 parts by weight of at least one kind of aromatic modified terpene resin selected from styrene, α-methylstyrene, and vinyltoluene and silica with respect to 100 parts by weight of diene-based rubber has been proposed (ref: for example, Patent Document 1).

### CITATION LIST

### Patent Document

Patent Document 1: International Patent Publication No. WO2013/001826

### SUMMARY OF THE INVENTION

### Problem to be Solved by the Invention

On the other hand, the tires are required to furthermore improve the low fuel consumption and the grip properties. Further, the tires are also required to furthermore improve the mechanical properties.

The present invention provides a rubber modifier for a tire and a rubber composition for a tire capable of obtaining a tire having excellent low fuel consumption, grip properties, and mechanical properties.

### Means for Solving the Problem

The present invention [1] includes a rubber modifier for a tire including rosins and/or terpenes and at least one kind of nitrogen-containing compound selected from the group consisting of a nitrogen-containing heterocyclic compound, a tertiary amine compound, and an amino alcohol.

The present invention [2] includes the rubber modifier for a tire described in the above-described [1], wherein the rosins include a stabilizing treatment rosin and/or stabilizing treatment rosin esters.

The present invention [3] include the rubber modifier for a tire described in the above-described [1] or [2], wherein the rosins include a disproportionated rosin and/or disproportionated rosin esters.

The present invention [4] includes the rubber modifier for a tire described in any one of the above-described [1] to [3], wherein the nitrogen-containing heterocyclic compound includes a tall oil fatty acid imidazoline.

The present invention [5] includes the rubber modifier for a tire described in any one of the above-described [1] to [4], wherein a ratio of the nitrogen-containing compound is 5 parts by mass or more and 30 parts by mass or less with respect to 100 parts by mass of the total amount of the rosins and/or the terpenes and the nitrogen-containing compound.

The present invention [6] includes a rubber composition for a tire including a rubber component, rosins and/or terpenes, and at least one kind of nitrogen-containing compound selected from the group consisting of a nitrogen-containing heterocyclic compound, a tertiary amine compound, and an amino alcohol.

The present invention [7] includes the rubber composition for a tire described in the above-described [6], wherein a total amount of the rosins and/or the terpenes and the nitrogen-containing compound is 5 parts by mass or more and 25 parts by mass or less with respect to 100 parts by mass of the rubber component.

### Effect of the Invention

The rubber modifier for a tire of the present invention can impart excellent low fuel consumption, grip properties, and mechanical properties to a tire produced from a rubber composition by being added to a rubber composition for a tire. That is, according to the rubber modifier for a tire of the present invention, it is possible to obtain a tire having excellent low fuel consumption, grip properties, and mechanical properties.

Also, according to the rubber composition for a tire of the present invention, it is possible to obtain a tire having excellent low fuel consumption, grip properties, and mechanical properties,

### DESCRIPTION OF EMBODIMENTS

A rubber modifier for a tire contains rosins and/or terpenes and a nitrogen-containing compound.

Examples of the rosins include non-modified rosins and rosin modified products.

Examples of the non-modified rosin include natural rosins.

The natural rosin is a natural resin containing a resin acid as a main component. The resin acid is a compound having carboxyl groups derived from trees.

Specifically, examples of the resin acid include resin acids having a conjugated double bond and resin acids having no conjugated double bond.

Examples of the resin acid having a conjugated double bond include abietic acid, palustric acid, neoabietic acid, and levopimaric acid.

Examples of the resin acid haying no conjugated double bond include dehydroabietic acid, dihydroabietic acid, and tetrahydroabietic acid.

More specifically, examples of the natural rosin include tall oil rosins, gum rosins, and wood rosins

These natural rosins may be used alone or in combination of two or more.

These non-modified rosins may be used alone or in combination of two or more.

As the non-modified rosin, preferably, a gum rosin is used.

The rosin modified product is a modified product of the above-described non-modified rosin.

Examples of the rosin modified product include rosin esters, unsaturated carboxylic acid-modified rosins, unsaturated carboxylic acid-modified rosin esters, stabilizing treatment rosins, and stabilizing treatment rosin esters.

The rosin esters can be obtained, for example, by subjecting the above-described non-modified rosin and a polyhydric alcohol and/or an amino alcohol to an ester reaction by a known method.

Examples of the polyhydric alcohol include dihydric alcohols, trihydric alcohols, and tetrahydric alcohols.

Examples of the dihydric alcohol include ethylene glycol, propylene glycol, neopentyl glycol, trimethylene glycol, tetramethylene glycol, 1,3-butanediol, and 1,6-hexanediol.

Examples of the trihydric alcohol include glycerin, trimethylolpropane, trimethylolethane, and triethylolethane.

Examples of the tetrahydric alcohol include pentaerythritol and dipentaerythritol.

These polyhydric alcohols may be used alone or in combination of two or more.

Examples of the amino alcohol include triethanolamine, tripropanolamine, triisopropanolamine, N-isobutyldiethanolamine, and N-normalbutyldiethanolamine.

These amino alcohols may be used alone or in combination of two or more.

As the polyhydric alcohol and/or the amino alcohol, preferably, a polyhydric alcohol is used, more preferably, a dihydric alcohol, a trihydric alcohol, and a tetrahydric alcohol are used, further more preferably, a trihydric alcohol and a tetrahydric alcohol are used, particularly preferably, a trihydric alcohol is used.

When the dihydric alcohol is used, the rosin esters are dirosin esters. In addition, when the trihydric alcohol is used, the rosin esters are trirosin esters. In addition, when the tetrahydric alcohol is used, the rosin esters are tetrarosin esters.

In other words, as the rosin esters, preferably, dirosin esters, trirosin esters, and tetrarosin esters are used, more preferably, trirosin esters and tetrarosin esters are used, further more preferably, trirosin esters are used.

In the above-described ester reaction, a mole ratio (OH/COOH) of hydroxyl groups of the polyhydric alcohol and/or the amino alcohol to carboxyl groups of the non-modified rosin is, for example, 0.2 to 1.2.

In addition, in the above-described ester reaction, a reaction temperature is, for example, 150 to 300° C., and the reaction time is, for example, 2 to 30 hours. In addition, in the above-described reaction, a known catalyst may be blended at an appropriate ratio if necessary.

The unsaturated carboxylic acid-modified rosins can be obtained, for example, by acid-modifying the above-described non-modified rosin with α,β-unsaturated carboxylic acids by a known method.

Examples of the α,β-unsaturated carboxylic acids include α,β-unsaturated carboxylic acids and acid anhydrides thereof.

More specifically, examples of the α,β-unsaturated carboxylic, acids include fumaric acid, maleic acid, maleic anhydride, itaconic acid, citraconic acid, citraconic anhydride, acrylic acid, and methacrylic acid.

These α,β-unsaturated carboxylic acids may be used alone or in combination of two or more.

As a mixing ratio of the non-modified rosin to the α,β-unsaturated carboxylic acids, a ratio of the α,β-unsaturated carboxylic acids is, for example, 1 mol or less with respect to 1 mol of the non-modified rosin.

In addition, in the reaction (acid modification) of the non-modified rosin with the α,β-unsaturated carboxylic acids, the reaction temperature is, for example, 150 to 300° C., and the reaction time is, for example, 1 to 24 hours. In addition, in the reaction, a known catalyst may be blended at an appropriate ratio if necessary.

The unsaturated carboxylic acid-modified rosin esters can be obtained, for example, by sequentially or simultaneously reacting the polyhydric alcohol and/or the amino alcohol described above and the above-described α,β-unsaturated carboxylic acids with the above-described non-modified rosin.

When the above-described components are sequentially reacted, first, the non-modified rosin and the polyhydric alcohol and/or the amino alcohol are subjected to an esterification reaction, and thereafter, the α,β-unsaturated carboxylic acids are reacted (acid-modified). Alternatively, for example, first, the non-modified rosin and the α,β-unsaturated carboxylic acids are reacted (acid-modified), and thereafter, the polyhydric alcohol and/or the amino alcohol are subjected to the esterification reaction.

In the unsaturated carboxylic acid-modified rosin esters, the reaction conditions of the esterification reaction and the reaction conditions of the acid modification can be the same as those described above.

As the unsaturated carboxylic acid-modified rosin esters, preferably, unsaturated carboxylic acid-modified dirosin esters, unsaturated carboxylic acid-modified trirosin esters, and unsaturated carboxylic acid-modified tetrarosin esters are used, more preferably, unsaturated carboxylic acid-modified trirosin esters and unsaturated carboxylic acid-modified tetrarosin esters are used, further more preferably, unsaturated carboxylic acid-modified trirosin esters are used.

The stabilizing treatment rosin is a modified product obtained by subjecting the above-described non-modified rosin to a stabilizing treatment.

The stabilizing treatment is a treatment for decreasing or eliminating a conjugated double bond in the resin acid having a conjugated double bond.

More specifically, examples of the stabilizing treatment include a hydrogenation treatment, a disproportionation treatment, and a polymerization treatment, and preferably, a hydrogenation treatment and a disproportionation treatment are used.

In other words, examples of the stabilizing treatment rosin include hydrogenated rosins obtained by subjecting a natural rosin to the hydrogenation treatment, disproportionated rosins obtained by subjecting the natural rosin to the disproportionation treatment, and polymerized rosins obtained by subjecting the natural rosin to the polymerization treatment. Further, examples of the stabilizing treatment rosin include hydrogenated products of the polymerization rosin.

These stabilizing treatment rosins may be used alone or in combination of two or more.

As the stabilizing treatment rosin, preferably, a hydrogenated rosin and a disproportionated rosin are used, more preferably, a disproportionated rosin is used.

The stabilizing treatment rosin esters can be obtained by subjecting the above-described stabilizing treatment rosin and the polyhydric alcohol and/or the amino alcohol described above to the esterification reaction by a known method,

In the stabilizing treatment rosin esters, the mole ratio (OH/COOH) of the hydroxyl groups of the polyhydric alcohol to the carboxyl groups of the stabilizing treatment rosin is, for example, 0.2 to 1.2. In addition, in the above-described esterification reaction, the reaction temperature is, for example, 150 to 300° C., and the reaction time is, for example, 2 to 30 hours. In addition, in the reaction, a known catalyst may be blended at an appropriate ratio if necessary.

As the stabilizing treatment rosin esters, preferably, stabilizing treatment dirosin esters, stabilizing treatment trirosin esters, and stabilizing treatment tetrarosin esters are used, more preferably, stabilizing treatment trirosin esters and stabilizing treatment tetrarosin esters are used, further more preferably, stabilizing treatment trirosin esters are used.

These rosin modified products may be used alone or in combination of two or more,

As the rosin modified product, preferably, a stabilizing treatment rosin and stabilizing treatment rosin esters are used.

These rosins may be used alone or in combination of two or more.

As the rosins, preferably, a rosin modified product is used, more preferably, a stabilizing treatment rosin and stabilizing treatment rosin esters are used, Further, as the stabilizing treatment rosin, preferably, a hydrogenated rosin and a disproportionated rosin are used. Further, as the stabilizing treatment rosin esters, preferably, a hydrogenated rosin ester and a disproportionated rosin ester are used.

As the rosins, further more preferably, a disproportionated rosin and rosin esters of a disproportionated rosin are used, particularly preferably, disproportionated rosin esters are used.

Examples of the terpenes include polyterpene resins and aromatic modified terpene resins. The polyterpene resin represents a terpene resin which is not aromatically modified,

More specifically, the polyterpene resin is a polymer of a terpene compound. The terpene compound is a compound containing a terpene skeleton as a basic skeleton, and an oxygen-containing derivative thereof The terpene skeleton is represented by the composition of (C₅H₈)ₙ. “n” indicates an integer of 1 or more. More specifically, examples of the terpene skeleton include monoterpene (C₁₀H₁₆), sesquiterpene (C₁₅H₁₄), and diterpene (C₂₀H₃₂). Examples of the compound containing a terpene skeleton as a basic skeleton include α-pinene, β-pinene, dipentene, limonene, myrcene, allo-ocimene, ocimene, α-phellandrene, α-terpinene, γ-terpinene, and terpinolene. Further, examples of the oxygen-containing derivative of the compound include 1,8-cineole, 1,4-cineole, α-terpineol, β-terpineol, and γ-terpineol. These may be used alone or in combination of two or more.

The polyterpene resin is not particularly limited as long as it is a resin in which the terpene compound is a raw material. Examples of the polyterpene resin include limonene resins, dipentene resins, and pinene/limonene resins. These may be used alone or in combination of two or more.

The pinene resin can be produced relatively easily. Further, since the pinene resin is obtained using a natural pine resin as a raw material, it is relatively inexpensive. Therefore, as the polyterpene resin, preferably, a pinene resin is used.

The pinene resin includes, for example, a portion derived from the α-pinene and a portion derived from the β-pinene. Examples of the pinene resin include an α-pinene resin containing the portion derived from the α-pinene as a main component and a β-pinene resin containing the portion derived from the β-pinene as a main component. These may be used alone or in combination of two or more.

Examples of the aromatic modified terpene resin include terpene phenol resins obtained by polymerization of a terpene compound and a known phenol-based compound. Examples of the phenol-based compound include phenol, bisphenol A, cresol, and xylenol.

Further, examples of the aromatic modified terpene resin include terpene styrene resins obtained by polymerization of a terpene compound and a known styrene-based compound. Examples of the styrene-based compound include styrene and α-methylstyrene.

Furthermore, examples of the aromatic modified terpene resin include terpene phenol styrene resins obtained by polymerization of a terpene compound, a known phenol-based compound, and a known styrene-based compound.

Examples of the terpenes include hydrogenated polyterpene resins and hydrogenated aromatic modified terpene resins. The hydrogenated polyterpene resin is obtained by hydrogenating a polyterpene resin by a known method. The hydrogenated aromatic modified terpene resin is obtained by hydrogenating an aromatic modified terpene resin by a known method.

These terpenes may be used alone or in combination of two or more. As the terpenes, preferably, a polyterpene resin and an aromatic modified terpene resin are used, more preferably, an aromatic modified terpene resin is used.

As the rosins and/or terpenes, from the viewpoint of productivity, preferably, rosins are used alone and terpenes are used alone. Further, as the rosins and/or the terpenes, from the viewpoint of low fuel consumption, more preferably, rosins are used alone.

The nitrogen-containing compound contains at least one kind selected from the group consisting of a nitrogen-containing heterocyclic compound, a tertiary amine compound, and an amino alcohol.

The nitrogen-containing compound preferably consists of at least one kind selected from the group consisting of the nitrogen-containing heterocyclic compound, the tertiary amine compound, and the amino alcohol.

Examples of the nitrogen-containing heterocyclic compound include imidazoline and derivatives thereof, imidazole and derivatives thereof, and imidazolinium betaine-based compounds.

Examples of the imidazoline and derivatives thereof include 1-hydroxyethyl-2-methylimidazoline, 1-hydroxyethyl-2-propylimidazoline, 1-hydroxyethyl-2-heptylimidazoline, 1-hydroxyethyl-2-nonylimidazoline, 1-hydroxyethyl-2-undecylimidazoline, 1-hydroxypropyl-2-methylimidazoline, 1-hydroxypropyl-2-propylimidazoline, 1-hydroxypropyl-2-heptylimidazoline, 1-hydroxypropyl-2-nonylimidazoline, 1-hydroxypropyl-2-undecylimidazoline, 1-hydroxybutyl-2-undecylimidazoline, and tall fatty acid imidazoline.

Examples of the imidazole and derivatives thereof include imidazole, 4-ethylaminoimidazole, 2-mercapto-1-methyl imidazole, 1-methylimidazole, 2,4,5-triphenylimidazole, 2-methylimidazole, 2-ethyl-4-methylimidazole, 2-heptadecylimidazole, 1,2-dimethylimidazole, and 2-phenylimidazole.

An example of the imidazolinium betaine-based compound includes 2-alkyl-N-carboxymethyl-N-hydroxyethylimidazolinium betaine.

These nitrogen-containing heterocyclic compounds may be used alone or in combination of two or more.

As the nitrogen-containing heterocyclic compound, preferably, imidazole and tall oil fatty acid imidazoline are used, more preferably, tall oil fatty acid imidazoline is used.

Examples of the tertiary amine compound include trioctylamine, trilautylamine, dimethylstearylamine (N,N-dimethylstearylamine), dimethyldecylamine, dimethylmyristylamine, dilauryl monornethylamine, dimethyloctadecenylamine, and dimethylhexadecenylamine.

These tertiary amine compounds may be used alone or in combination of two or more.

As the tertiary amine compound, preferably, dimethylstearylamine is used.

Examples of the amino alcohol include a primary amino alcohol, a secondary amino alcohol, a primary and secondary combined amino alcohol, and a tertiary amino alcohol.

Examples of the primary amino alcohol include ethanolamine (monoethanolamine, 2-aminoethanol), propanolamine (monopropanolamine, 3-amino-1-propanol), 1-amino-2-propanol, butanolamine (monobutanolamine, 1-amino-1-butanol), 2-amino-1-butanol, pentanolamine (monopentanolamine, 5-amino-1-pentanol), hexanolamine (monohexanolamine, 6-amino-1-hexanol), 2-(2-aminoethoxy)ethanol, and 2-amino-2-ethyl-1,3-propanediol.

Examples of the secondary amino alcohol include N-methylethanolamine, N-ethylethanolamine, N-n-propylethanolamine, N-n-butylethanolamine, N-t-butylethanolamine, N-pentylethanolamine, N-hexylethanolamine, N-heptylethanolamine, N-octylethanolamine, N-(β-aminoethyl)ethanolamine, N-(β-aminoethyl)propanolamine, diethanolamine, 2-(isopropylamino)ethanol, 2-(t-butoxycarbonylamino)-1-ethanol, and 2-(t-butylamino)ethanol,

Examples of the primary and secondary combined amino alcohol include N-(β-aminoethyl)isopropanolamine and N-(3-hydroxypropyl)ethylenediamine.

Examples of the tertiary amino alcohol include N-methyl-N,N-diethanolamine, N-ethyl-N,N-diethanolamine, N-n-butyl-N,N-diethanolamine, N-t-butyl-N,N-diethanolamine, N,N-dimethylethanolamine, N,N-diethylethanolamine, N,N-dibutylethanolamine, N,N-diethylpropanolamine, N,N-diethylisopropanolamine, N,N-dibutylethanolamine (also known as 2-(dibutylamino)ethanol), 2-[[2-(dimethylamino)ethyl]methylamino]ethanol, N-ethyl-N-(2-hydroxyethyl)nitrosoamine, N,N,N′-trimethyl-N′-(2-hydroxyethyl)bis(2-aminoethyl)ether, 2-[2-(dimethylamino)ethoxy]ethanol, 2-(diisopropylamino)ethanol, and triethanolamine.

These amino alcohols may be used alone or in combination of two or more.

As the amino alcohol, preferably, a primary amino alcohol and a secondary amino alcohol are used, more preferably, a secondary amino alcohol is used, father more preferably, N-(β-aminoethyl)pethanolamine and N-n-butylethanolamine are used, particularly preferably, N-(β-aminoethyl)ethanolamine is used.

These nitrogen-containing compounds may be used alone or in combination of two or more.

As the nitrogen-containing compound, preferably, a nitrogen-containing heterocyclic compound is used alone, a tertiary amine compound is used alone, and an amino alcohol is used alone, more preferably, a nitrogen-containing heterocyclic compound is used alone.

Further, as the nitrogen-containing compound, preferably, a nitrogen-containing heterocyclic compound and an amino alcohol are used, more preferably, a nitrogen-containing heterocyclic compound is used, further more preferably, a tall oil fatty acid imidazoline is used.

The rubber modifier for a tire may be also prepared by mixing, for example, the rosins and/or the terpenes with the nitrogen-containing compound before being added to a rubber component to be described later.

Further, the rubber modifier for a tire may be also prepared in the rubber component by sequentially or simultaneously adding the rosins and/or the terpenes and the nitrogen-containing compound to the rubber component to be described later.

A content ratio (total sum when used in combination) of the rosins and/or the terpenes is for example, 50 parts by mass or more, preferably 55 parts by mass or more, more preferably 60 parts by mass or more, further more preferably 70 parts by mass or more, particularly preferably 75 parts by mass or more, and for example, 99 parts by mass or less, preferably 95 parts by mass or less, more preferably 90 parts by mass or less, further more preferably 85 parts by mass or less with respect to 100 parts by mass of the total amount of rosins and/or the terpenes and the nitrogen-containing compound. The content ratio of the nitrogen-containing compound is, for example. 1 part by mass or more, preferably 5 parts by mass or more, more preferably 10 parts by mass or more, further more preferably 15 parts by mass or more, and for example, 50 parts by mass or less, preferably 45 parts by mass or less, more preferably 40 parts by mass or less, further more preferably 30 parts by mass or less, particularly preferably 25 parts by mass or less.

In addition, the content ratio (total sum when used in combination) of the rosins and/or the terpenes is, for example, 100 parts by mass or more, preferably 150 parts by mass or more, more preferably 300 parts by mass or more, further more preferably 310 parts by mass or more, particularly preferably 400 parts by mass or more, and for example, 1200 parts by mass or less, preferably 600 parts by mass or less, more preferably 500 parts by mass or less, further more preferably 480 parts by mass or less, particularly preferably 450 parts by mass or less with respect to 100 parts by mass of the nitrogen-containing compound.

The rubber modifier for a tire may further contain an additive.

Examples of the additive include known additives such as dispersants, vulcanization accelerators, reinforcing materials, anti-aging agents, deterioration inhibitors, crack inhibitors, silane coupling agents, vulcanization retarders, vulcanization activators, plasticizers, softeners, oils, anti-aging agents, and fillers.

These additives may be used alone or in combination of two or more.

The content ratio of the additive is appropriately set as long as it is within a range which does not inhibit the excellent effect of the present invention.

Then, such a rubber modifier for a tire can impart excellent low fuel consumption, grip properties, and mechanical properties to a tire produced from the rubber composition by being added to the rubber composition for a tire. In addition, of the grip properties, according to the above-described rubber modifier for a tire, it is possible to improve the wet grip properties.

That is, it is possible to obtain the tire haying the above-described excellent low fuel consumption, excellent grip properties, and excellent mechanical properties.

More specifically, the rubber composition for a tire for obtaining a tire contains the rosins and/or the terpenes and the nitrogen-containing compound described above.

As described above, the rosins and/or the terpenes and the nitrogen-containing compound may be mixed in advance. In such a case, the above-described rubber modifier for a tire is prepared as a mixture of the rosins and/or the terpenes and the nitrogen-containing compound.

Further, the rosins and/or the terpenes and the nitrogen-containing compound may be sequentially or simultaneously added to the rubber component to be described later. In such a case, the rubber modifier for a tire including the rosins and/or the terpenes and the nitrogen-containing compound in the rubber component is prepared.

In other words, the rubber composition for a tire includes the rosins and/or the terpenes, the nitrogen-containing compound, and the rubber component.

The rubber component is not particularly limited, and examples thereof include diene-based rubbers.

The diene-based rubber is not particularly limited, and examples thereof include natural rubbers (NR), styrene butadiene rubbers (SBR), butadiene rubbers (BR), isoprene rubbers (IR), butyl rubbers (IIR), acrylonitrile butadiene rubbers (NBR), ethylene propylene diene rubbers (EPDM), and chloroprene rubbers (CR).

These rubber components may be used alone or in combination of two or more.

From the viewpoint of improving the strength and abrasion resistance of a molded article to be obtained, as the rubber component, preferably, natural rubber (NR), styrene butadiene rubber (SBR), and butadiene rubber (BR) are used, more preferably, styrene butadiene rubber (SBR) and butadiene rubber (BR) are used in combination.

When the styrene butadiene rubber (SBR) and the butadiene rubber (BR) are used in combination, as a combination ratio of these, a ratio of the styrene butadiene rubber (SBR) is, for example, 40 parts by mass or more, preferably 60 parts by mass or more, and for example, 95 parts by mass or less, preferably 85 parts by mass or less with respect to 100 parts by mass of the total amount of the styrene butadiene rubber (SBR) and the butadiene rubber (BR). Further, a ratio of the butadiene rubber (BR) is, for example. 5 parts by mass or more, preferably 15 parts by mass or more, and for example, 60 parts by mass or less, preferably 40 parts by mass or less.

When the combination ratio of the styrene butadiene rubber (SBR) and the butadiene rubber (BR) is within the above-described range, it is possible to improve the strength and the abrasion resistance of the molded article to be obtained.

In the rubber composition for a tire, the content ratio of the rosins and/or the terpenes (total sum when used in combination) is appropriately set in accordance with its purpose and application. For example, the content ratio of the rosins and/or the terpenes is, for example, 0.1 parts by mass or more, preferably 1 part by mass or more, more preferably 2 parts by mass or more, further more preferably 5 parts by mass or more, even more preferably 7 parts by mass or more, and for example, 30 parts by mass or less, preferably 25 parts by mass or less, more preferably 20 parts by mass or less, further more preferably 18 parts by mass or less, even more preferably 10 parts by mass or less with respect to 100 parts by mass of the rubber component.

In addition, in the rubber composition for a tire, the content ratio of the nitrogen-containing compound is appropriately set in accordance with its purpose and application. The content ratio of the nitrogen-containing compound is, for example, 0.01 parts by mass or more, preferably 0.1 parts by mass or more, more preferably 0.5 parts by mass or more, further more preferably 1.5 parts by mass or more, even more preferably 1.8 parts by mass or more, and for example, 15 parts by mass or less, preferably 10 parts by mass or less, more preferably 6 parts by mass or less, further more preferably 4.5 parts by mass or less with respect to 100 parts by mass of the rubber component.

In addition, in the rubber composition for a tire, the total amount of the content ratio (total sum when used in combination) of the rosins and/or the terpenes and the content ratio of the nitrogen-containing compound is appropriately set in accordance with its purpose and application. The total amount of the content ratio (total sum when used in combination) of the rosins and/or the terpenes and the content ratio of the nitrogen-containing compound is, for example, 0.1 parts by mass or more, preferably I part by mass or more, more preferably 2 parts by mass or more, further more preferably 5 parts by mass or more, even more preferably 7 parts by mass or more, and for example, 30 parts by mass or less, preferably 25 parts by mass or less, more preferably 23 parts by mass or less, further more preferably 20 parts by mass or less, particularly preferably 10 parts by mass or less with respect to 100 parts by mass of the rubber component.

Further, the rubber composition for a tire may contain a filler.

Examples of the filler include inorganic fillers and organic fillers.

Examples of the inorganic filler include calcium carbonate, magnesium carbonate, silicic acid and salts thereof, silica, clay, talc, mica powder, bentonite, alumina, aluminum silicate, carbon (acetylene black etc.), and aluminum powder.

An example of the organic filler includes cork.

These fillers may be used alone or in combination of two or more.

When the filler is blended, a mixing ratio thereof is appropriately set in accordance with its purpose and application.

Further, the rubber composition for a tire preferably contains a vulcanizing agent.

An example of e vulcanizing agent includes sulfur.

The sulfur is not particularly limited, and examples thereof include powdered sulfur, precipitated sulfur, colloidal sulfur, insoluble sulfur, and highly dispersible sulfur.

These vulcanizing agents may be used alone or in combination of two or more.

The mixing ratio of the vulcanizing agent is, for example, 0.5 parts by mass or more, preferably 1 part by mass or more, and for example, 5 parts by mass or less, preferably 3 parts by mass or less with respect to 100 parts by mass of the rubber component.

Further, the rubber composition for a tire preferably contains a vulcanization accelerator.

Examples of the vulcanization accelerator include zinc oxide, stearic acid, sulfenamide-based vulcanization accelerators, and guanidine-based vulcanization accelerators.

Examples of the sulfenamide-based vulcanization accelerator include N-tert-butyl-2-benzothiazolyl sulfenamide (TBBS), N-cyclohexyl-2-benzothiazolyl sulfenamide (CBS). N,N-dicyclohexyl-2-benzothiazolyl sulfenamide (DCBS), and N,N-diisopropyl-2-benzothiazol sulfenamide.

Examples of the guanidine-based vulcanization accelerator include diphenylguanidine (DPG), diorthotolylguanidine, triphenyiguanidine, orthotolyibiguanide, and diphenylguanidine phthalate.

These vulcanization accelerators may be used alone or in combination of two or more.

The mixing ratio of the vulcanization accelerator is appropriately set in accordance with its purpose and application.

Furthermore, a known additive may be blended into the rubber composition for a tire at an appropriate ratio if necessary.

Examples of the additive include deterioration inhibitors, crack inhibitors, silane coupling agents, vulcanization aids, vulcanization retarders, vulcanization activators, plasticizers, softeners, and anti-aging agents. Further, examples of the deterioration inhibitor include ozone deterioration inhibitors, thennal deterioration inhibitors, and oxidation deterioration inhibitors.

These additives may be blended in advance in at least any of the above-described components, or may be blended simultaneously at the time of mixing them.

Then, the rubber composition for a tire can be obtained by mixing each of the above-described components.

A mixing method is not particularly limited, and for example, a known kneading machine for a rubber such as a roll, a Banbury mixer, and a kneader can be used. In addition, the mixing conditions are not particularly limited, and are appropriately set in accordance with a device to be used or the like.

Since, the rubber composition for a tire includes the above-described rubber modifier for a tire, it is possible to obtain a tire having excellent low fuel consumption, grip properties, and mechanical properties. Of the grip properties, according to the above-described rubber composition for a tire, it is possible to improve the wet grip properties.

Then, the above-described rubber composition for a tire is used for the production of tires.

A method for producing a tire using the above-described rubber composition for a tire is not particularly limited, and a known vulcanization molding method can be used.

In other words, for example, first, the rubber composition for a tire in an unvulcanized state is extruded according to a shape of the tire, and the unvulcanized tire is formed on a tire molding machine. Next, the unvulcanized tire is heated and pressurized in a vulcanizer, and vulcanized. In addition, the unvulcanized tire may be attached to another tire member in the tire molding machine. Examples of the other tire member include side wall portions, shoulder portions, bead portions, and inner liners.

Since the tire thus obtained contains the above-described rubber modifier for a tire, it has excellent low fuel consumption, grip properties, and mechanical properties, and in particular, has excellent low fuel consumption, wet grip properties, and mechanical properties.

Therefore, the tire thus obtained is preferably used, for example, as tires for various vehicles such as cars, motorcycles, and railway vehicles (for example, monorails etc.), and for example, as tires for airplanes or the like.

### EXAMPLES

Next, the present invention is further described based on Examples and Comparative Examples. The present invention is however not limited by the following Examples. All designations of “part” or “parts” and “%” mean part or parts by mass and % by mass, respectively, unless otherwise particularly specified. Further, the specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

### Synthetic Example 1 (Disproportionated Rosin)

A tall rosin (800 g) (unmodified rosin, trade name: HARTALL R-WW, manufactured by Harima Chemicals Group, Inc.) was taken into a four-necked flask and melted at 150° C. under a nitrogen stream.

Then, 3.3 g of 6% iron octylate and 25 g of iodine were put in a flask, and the mixture was heated to 230° C. to react for 1.5 hours.

Thereafter, a low-boiling point material was removed by reduced pressure steam distillation under nitrogen aeration.

Thus, a disproportionated rosin was obtained.

### Synthetic Example 2. (Disproportionated Rosin Triester)

In a nitrogen-substituted 2000-mL four-necked flask, 1200 g of disproportionated rosin was charged and heated to 180° C., thereby dissolving the disproportionated rosin.

Then, 126.42 g of glycerin was added, 1.24 g of esterification catalyst was added, the temperature of the resulting mixture was increased stepwise to 275° C., and the reaction was carried out for 18 hours.

Then, the low-boiling point material was distilled off at 275° C. under reduced pressure conditions of 0.086 MPa for one hour.

Thus, a disproportionated rosin triester was obtained.

Examples 1 to 14 and Comparative Examples 1 to 3 (Rubber Modifier for Tire) A rubber modifier for a tire was obtained by blending rosins and/or terpenes and a nitrogen-containing compound in the formulation shown in Table 1 to be stirred for 10 minutes with a wide-mouthed bottle at 150° C.

In Comparative Example 1. the nitrogen-containing compound was not used, and an aromatic modified terpene resin was used alone.

In Comparative Example 2, the nitrogen-containing compound was not used, and a terpene resin was used alone.

In Comparative Example 3, the rosins and the terpenes were not used, and the nitrogen-containing compound was used alone.

TABLE 1

| No. | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Mixing | Rosins | Disproportionated Rosin Triester | 80 | 76 | 82 | 83 | 61 | 75 | — | — |
| Formulation | | Hydrogenated Rosin Triester | — | — | — | — | — | — | 80 | — |
| (parts by | | Disproportionated Rosin | — | — | — | — | — | — | — | 80 |
| mass) | Terpenes | Aromatic Modified Terpene Resin | — | — | — | — | — | — | — | — |
| | Nitrogen- | Tall Oil Fatty Acid Imidazoline | 20 | 24 | 18 | 17 | 39 | 25 | 20 | 20 |
| | Containing | Amino Alcohol | — | — | — | — | — | — | — | — |
| | Compound | Imidazole | — | — | — | — | — | — | — | — |
| | | Dimethylstearylamine | — | — | — | — | — | — | — | — |

| | | | | | | | | |
|---|---|---|---|---|---|---|---|---|
| Rosins-Terpenes/Nitrogen-Containing Compound (mass ratio) | 4.0 | 3.2 | 4.6 | 4.9 | 1.6 | 3.0 | 4.0 | 4.0 |

| No. | | | Ex. 9 | Ex. 10 | Ex. 11 | Ex. 12 | Ex. 13 | Ex. 14 |
|---|---|---|---|---|---|---|---|---|
| Mixing | Rosins | Disproportionated Rosin Triester | 80 | 80 | 80 | 91 | 57 | — |
| Formulation | | Hydrogenated Rosin Triester | — | — | — | — | — | — |
| (parts by | | Disproportionated Rosin | — | — | — | — | — | — |
| mass) | Terpenes | Aromatic Modified Terpene Resin | — | — | — | — | — | 80 |
| | Nitrogen- | Tall Oil Fatty Acid Iimidazoline | — | — | — | 9 | 43 | 20 |
| | Containing | Amino Alcohol | 20 | — | — | — | — | — |
| | Compound | Imidazole | — | 20 | — | — | — | — |
| | | Dimethylstearylamine | — | — | 20 | — | — | — |

| | | | | | | |
|---|---|---|---|---|---|---|
| Rosins-Terpenes/Nitrogen-Containing Compound (mass ratio) | 4.0 | 4.0 | 4.0 | 10.1 | 1.3 | 4.0 |

| | | | Comparative | Comparative | Comparative |
|---|---|---|---|---|---|
| No. | | | Ex. 1 | Ex. 2 | Ex. 3 |
| Mixing | Rosins | Disproportionated Rosin Triester | — | 100 | — |
| Formulation | | Hydrogenated Rosin Triester | — | — | — |
| (parts by | | Disproportionated Rosin | — | — | — |
| mass) | Terpenes | Aromatic Modified Terpene Resin | 100 | — | — |
| | Nitrogen- | Tall Oil Fatty Acid Imidazoline | — | — | 100 |
| | Containing | Amino Alcohol | — | — | — |
| | Compound | Imidazole | — | — | — |
| | | Dimethylstearylamine | — | — | — |

| | | | |
|---|---|---|---|
| Rosins-Terpenes/Nitrogen-Containing Compound (mass ratio) | — | — | — |

The details of abbreviations in Table are described below.

Disproportionated rosin triester: Synthetic Example 2

Hydrogenated rosin triester: trade name: HARITACK F85, manufactured by Harima Chemicals Group, Inc.

Disproportionated rosin: Synthetic Example 1

Tall rosin: trade name: HARTALL R-WW, manufactured by Harima Chemicals Group, Inc.

Aromatic modified terpene resin: trade name: VS resin TO125, manufactured by YASUHARA CHEMICAL CO., LTD,

Toll oil fatty acid imidazoline: trade name: HARTALL M-33, manufactured by Harima Chemicals Group, Inc.

Amino alcohol: trade name: Amino Alcohol EA, N-(β-aminoethyl)ethanolamine, manufactured by Nippon Nyukazai Co., Ltd.

Imidazole: trade name: Imidazole, manufactured by Tokyo Chemical Industry Co., Ltd.

Dimethylstearylamine: trade name: N,N-dimethylstearylamine, manufactured by Tokyo Chemical industry Co., Ltd.

Examples 15 to 31 and Comparative Examples 4 to 6 (Rubber Composition for Tire)

In the formulations shown in Tables 2 and 3, a rubber modifier for a tire, a styrene butadiene rubber (SBR), a polybutadiene rubber (BR), silica, an oil, an ozone deterioration inhibitor, zinc oxide, stearie acid, and a silane coupling agent were mixed and kneaded using a Labo Plastomill (manufactured by Toyo Seiki Seisaku-sho, Ltd.) under the conditions of a set temperature of 150° C. for 2 minutes, thereby obtaining a kneaded product.

Then, in the formulations shown in Tables 2 and 3, sulfur, a sulfenamide-based vulcanization accelerator, and a guanidine-based vulcanization accelerator were added to the obtained kneaded product to be mixed using the Labo Plastomill, thereby obtaining an unvulcanized rubber composition.

Thereafter, the obtained unvulcanized rubber composition was molded into a sheet shape and press-vulcanized under the conditions of 160° C., thereby obtaining a molded article having a thickness of 2 mm.

TABLE 2

| No. | | | Ex. 15 | Ex. 16 | Ex. 17 | Ex. 18 | Ex. 19 | Ex. 20 | Ex. 21 | Ex. 22 | Ex. 23 | Ex. 24 |
|---|---|---|---|---|---|---|---|---|---|---|---|---|
| Mixing | Rubber Modifier | Ex. 1 | 10 | — | — | — | — | — | 20 | 5 | 25 | — |
| Formulation | for Tire | Ex. 2 | — | 10 | — | — | — | — | — | — | — | — |
| (parts by | | Ex. 3 | — | — | 10 | — | — | — | — | — | — | — |
| mass) | | Ex. 4 | — | — | — | 10 | — | — | — | — | — | — |
| | | Ex. 5 | — | — | — | — | 10 | — | — | — | — | — |
| | | Ex. 6 | — | — | — | — | — | 10 | — | — | — | — |
| | | Ex. 7 | — | — | — | — | — | — | — | — | — | 10 |
| | | Ex. 8 | — | — | — | — | — | — | — | — | — | — |
| | | Ex. 9 | — | — | — | — | — | — | — | — | — | — |
| | | Ex. 10 | — | — | — | — | — | — | — | — | — | — |
| | | Ex. 11 | — | — | — | — | — | — | — | — | — | — |
| | | Ex. 12 | — | — | — | — | — | — | — | — | — | — |
| | | Ex. 13 | — | — | — | — | — | — | — | — | — | — |
| | | Ex. 14 | — | — | — | — | — | — | — | — | — | — |
| | | Comparative | — | — | — | — | — | — | — | — | — | — |
| | | Ex. 1 | | | | | | | | | | |
| | | Comparative | — | — | — | — | — | — | — | — | — | — |
| | | Ex. 2 | | | | | | | | | | |
| | | Comparative | — | — | — | — | — | — | — | — | — | — |
| | | Ex. 3 | | | | | | | | | | |

| | | | | | | | | | | |
|---|---|---|---|---|---|---|---|---|---|---|
| SBR | 70 | 70 | 70 | 70 | 70 | 70 | 70 | 70 | 70 | 70 |
| BR | 30 | 30 | 30 | 30 | 30 | 30 | 30 | 30 | 30 | 30 |
| Silica | 70 | 70 | 70 | 70 | 70 | 70 | 70 | 70 | 70 | 70 |
| Oil | 20 | 20 | 20 | 20 | 20 | 20 | 10 | 25 | 5 | 20 |
| Deterioration Inhibitor | 1 | 1 | 1 | 1 | 1 | 1 | 1 | 1 | 1 | 1 |
| Zinc Oxide | 3 | 3 | 3 | 3 | 3 | 3 | 3 | 3 | 3 | 3 |
| Stearic Acid | 2 | 2 | 2 | 2 | 2 | 2 | 2 | 2 | 2 | 2 |
| Silane Coupling Agent | 5.6 | 5.6 | 5.6 | 5.6 | 5.6 | 5.6 | 5.6 | 5.6 | 5.6 | 5.6 |
| Sulfur | 1.5 | 1.5 | 1.5 | 1.5 | 1.5 | 1.5 | 1.5 | 1.5 | 1.5 | 1.5 |
| Vulcanization Accelerator 1 | 2.7 | 2.7 | 2.7 | 2.7 | 2.7 | 2.7 | 2.7 | 2.7 | 2.7 | 2.7 |
| Vulcanization Accelerator 2 | 2.3 | 2.3 | 2.3 | 2.3 | 2.3 | 2.3 | 2.3 | 2.3 | 2.3 | 2.3 |

TABLE 3

| | | | | | | | | | | Compar- | Compar- | Compar- |
|---|---|---|---|---|---|---|---|---|---|---|---|---|
| | | | | | | | | | | ative | ative | ative |
| No. | | | Ex. 25 | Ex. 26 | Ex. 27 | Ex. 28 | Ex. 29 | Ex. 30 | Ex. 31 | Ex. 4 | Ex. 5 | Ex. 6 |
| Mixing | Rubber | Ex. 1 | — | — | — | — | — | — | — | — | — | — |
| Formulation | Modifier | Ex. 2 | — | — | — | — | — | — | — | — | — | — |
| (parts by | for Tire | Ex. 3 | — | — | — | — | — | — | — | — | — | — |
| mass) | | Ex. 4 | — | — | — | — | — | — | — | — | — | — |
| | | Ex. 5 | — | — | — | — | — | — | — | — | — | — |
| | | Ex. 6 | — | — | — | — | — | — | — | — | — | — |
| | | Ex. 7 | — | — | — | — | — | — | — | — | — | — |
| | | Ex. 8 | 10 | — | — | — | — | — | — | — | — | — |
| | | Ex. 9 | — | 10 | — | — | — | — | — | — | — | — |
| | | Ex. 10 | — | — | 10 | — | — | — | — | — | — | — |
| | | Ex. 11 | — | — | — | 10 | — | — | — | — | — | — |
| | | Ex. 12 | — | — | — | — | 10 | — | — | — | — | — |
| | | Ex. 13 | — | — | — | — | — | 10 | — | — | — | — |
| | | Ex. 14 | — | — | — | — | — | — | 10 | — | — | — |
| | | Comparative | — | — | — | — | — | — | — | 10 | — | — |
| | | Ex. 1 | | | | | | | | | | |
| | | Comparative | — | — | — | — | — | — | — | — | 10 | — |
| | | Ex. 2 | | | | | | | | | | |
| | | Comparative | — | — | — | — | — | — | — | — | — | 10 |
| | | Ex. 3 | | | | | | | | | | |

| | | | | | | | | | | |
|---|---|---|---|---|---|---|---|---|---|---|
| SBR | 70 | 70 | 70 | 70 | 70 | 70 | 70 | 70 | 70 | 70 |
| BR | 30 | 30 | 30 | 30 | 30 | 30 | 30 | 30 | 30 | 30 |
| Silica | 70 | 70 | 70 | 70 | 70 | 70 | 70 | 70 | 70 | 70 |
| Oil | 20 | 20 | 20 | 20 | 20 | 20 | 20 | 20 | 20 | 20 |
| Deterioration Inhibitor | 1 | 1 | 1 | 1 | 1 | 1 | 1 | 1 | 1 | 1 |
| Zinc Oxide | 3 | 3 | 3 | 3 | 3 | 3 | 3 | 3 | 3 | 3 |
| Stearic Acid | 2 | 2 | 2 | 2 | 2 | 2 | 2 | 2 | 2 | 2 |
| Silane Coupling Agent | 5.6 | 5.6 | 5.6 | 5.6 | 5.6 | 5.6 | 5.6 | 5.6 | 5.6 | 5.6 |
| Sulfur | 1.5 | 1.5 | 1.5 | 1.5 | 1.5 | 1.5 | 1.5 | 1.5 | 1.5 | 1.5 |
| Vulcanization Accelerator 1 | 2.7 | 2.7 | 2.7 | 2.7 | 2.7 | 2.7 | 2.7 | 2.7 | 2.7 | 2.7 |
| Vulcanization Accelerator 2 | 2.3 | 2.3 | 2.3 | 2.3 | 2.3 | 2.3 | 2.3 | 2.3 | 2.3 | 2.3 |

The details of abbreviations in Table are described below.

SBR: styrene butadiene rubber, trade name: HPR850, manufactured by JSR Corporation

BR: polybutadiene rubber, trade name: BR01, manufactured by JSR Corporation

Silica: inorganic filler, trade name: Nipsil AQ, manufactured by TOSOH SILICA CORPORATION

Oil: plasticizer, trade name: TDAE (treatment distillation aromatic distillate), manufactured by Takehara Rubber Co., Ltd.

Deterioration inhibitor: ozone deterioration inhibitor, trade name: OZONONE 6C, manufactured by Seiko Chemical Co., Ltd.

Zinc oxide: vulcanization accelerator, trade name: Zinc Oxide, manufactured by SEIDO CHEMICAL INDUSTRY CO., LTD.

Stearic acid: vulcanization accelerator, trade name: stearic acid “Tsubaki”, manufactured by NOF CORPORATION

Silane coupling agent: trade name Si75, manufactured by Evonic industries AG

Sulfur: vulcanizing agent, trade name: Oil Sulfur, manufactured by HOSOI CHEMICAL INDUSTRY CO., LTD.

Vulcanization accelerator 1: sulfenamide-based vulcanization accelerator, trade name: CZ, manufactured by OUCHI SHINKO CHEMICAL INDUSTRIAL CO., LTD.

Vulcanization accelerator 2: guanidine-based vulcanization accelerator, trade name: SOXINOL D/DG, manufactured by SUMITOMO CHEMICAL COMPANY, LIMITED

### <Evaluation>

Each molded article obtained in Examples and Comparative Examples was evaluated by the following method. The results are shown in Table 4.

### (1) Mechanical Properties (Breaking Strength, Breaking Elongation)

A tensile test was carried out at a tensile rate of 500 mm/min using a No. 3 dumbbell in conformity with JIS K6251 (2010).

Thus, the breaking strength (TB) and the breaking elongation (EB) of a molded article were measured.

The breaking strength (TB) and the breaking elongation (EB) in Comparative Example 4 were set at a reference value of 100.

Then, each of the breaking strength (TB) and EB in Examples and Comparative Examples was denoted as an index.

As for the breaking strength (TB), the larger the index value, the more excellent the mechanical properties, and when the value was 105 or more, the case was judged to be especially excellent,

As for the breaking elongation (EB), the larger the index value, the more excellent the mechanical properties, and when the value was 105 or more, the case was judged to be especially excellent.

### (2) Low Fuel Consumption and Grip Properties

A loss tangent tan δ was measured at the temperature of 0° C. and 60° C. using a dynamic viscoelasticity measuring device E4000-HP (manufactured by UBM) under the following conditions.

Measurement mode: tensile mode

Measurement conditions: frequency of 10 Hz, initial distortion of 10%, dynamic distortion of 0.025%

Temperature dispersion conditions: −60° C. to 60° C.

Then, the tan δ at 0° C. was evaluated as grip properties (wet grip properties).

And, the tan δ at 60° C. was evaluated as low fuel consumption (rolling resistance).

The tan δ in Comparative Example 4 was set at a reference value of 100.

Then, each tan δ in Examples and Comparative Examples was denoted as an index.

As for the tan δ at 0° C., the larger the index value, the more excellent the grip properties wet grip properties), and when the value was 105 or more, the case was judged to be especially excellent.

As for the tanδ at 60° C., the smaller the index value, the more excellent the low fuel consumption (rolling resistance), and when the value was 95 or less, the case was judged to be especially excellent.

### (3) Overall Evaluation

A case which satisfied the following four criteria was evaluated as A in overall evaluation.

Further, a case which satisfied the following three criteria was evaluated as B in overall evaluation.

Further, a case which satisfied the following two criteria was evaluated as C in overall evaluation.

Further, a case which did not satisfy any one of the following criteria or satisfied only one criterion was evaluated as D in overall evaluation.

### (Evaluation Criteria)

(i) An index value of the breaking strength (TB) is 105 or more.

(ii) An index value of the breaking elongation (EB) is 105 or more.

(iii) An index value of the tan δ at 0° C. is 105 or more.

(iv) An index value of the tan δ at 60° C. is 95 or less.

TABLE 4

| No. | | | Ex. 15 | Ex. 16 | Ex. 17 | Ex. 18 | Ex. 19 | Ex. 20 | Ex. 21 | Ex. 22 | Ex. 23 | Ex. 24 |
|---|---|---|---|---|---|---|---|---|---|---|---|---|
| Evaluation | Mechanical | Breaking | 108 | 108 | 110 | 106 | 107 | 107 | 117 | 104 | 120 | 104 |
| | Properties | Strength | | | | | | | | | | |
| | | Breaking | 109 | 108 | 109 | 101 | 102 | 101 | 113 | 106 | 120 | 100 |
| | | Elongation | | | | | | | | | | |
| | Grip | 0° C. tan δ | 111 | 114 | 110 | 108 | 106 | 106 | 131 | 107 | 139 | 109 |
| | Properties | | | | | | | | | | | |
| | Low Fuel | 60° C. tan δ | 88 | 89 | 88 | 89 | 95 | 88 | 94 | 83 | 98 | 89 |
| | Consumption | | | | | | | | | | | |

| | | | | | | | | | | |
|---|---|---|---|---|---|---|---|---|---|---|
| Overall Evaluation | A | A | A | B | B | B | A | B | B | C |

| | | | | | | | | | | Comparative | Comparative | Comparative |
|---|---|---|---|---|---|---|---|---|---|---|---|---|
| No. | | | Ex. 25 | Ex. 26 | Ex. 27 | Ex. 28 | Ex. 29 | Ex. 30 | Ex. 31 | Ex. 4 | Ex. 5 | Ex. 6 |
| Evaluation | Mechanical | Breaking | 120 | 109 | 113 | 110 | 102 | 105 | 122 | 100 | 99 | 99 |
| | Properties | Strength | | | | | | | | | | |
| | | Breaking | 125 | 106 | 104 | 104 | 102 | 102 | 139 | 100 | 103 | 128 |
| | | Elongation | | | | | | | | | | |
| | Grip | 0° C. tan δ | 106 | 111 | 106 | 103 | 105 | 102 | 118 | 100 | 94 | 74 |
| | Properties | | | | | | | | | | | |
| | Low Fuel | 60° C. tan δ | 97 | 89 | 87 | 88 | 91 | 95 | 97 | 100 | 92 | 152 |
| | Consumption | | | | | | | | | | | |

| | | | | | | | | | | |
|---|---|---|---|---|---|---|---|---|---|---|
| Overall Evaluation | B | A | B | C | C | C | B | D | D | D |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The rubber modifier for a tire and the rubber composition for a tire of the present invention are preferably used in, for example, the fields of vehicle tires and airplane tires.

1. A rubber modifier for a tire comprising:
rosins and/or terpenes and
at least one kind of nitrogen-containing compound selected from the group consisting of a nitrogen-containing heterocyclic compound, a tertiary amine compound, and an amino alcohol.

2. The rubber modifier for a tire according to claim 1, wherein
the rosins include a stabilizing treatment rosin and/or stabilizing treatment rosin esters.

3. The rubber modifier for a tire according to claim 1, wherein
the rosins include a disproportionated rosin and/or disproportionated rosin esters.

4. The rubber modifier for a tire according to claim 1, wherein
the nitrogen-containing heterocyclic compound includes a tall oil fatty acid imidazoline.

5. The rubber modifier for a tire according to claim 1, wherein
a ratio of the nitrogen-containing compound is 5 parts by mass or more and 30 parts by mass or less with respect to 100 parts by mass of the total amount of the rosins and/or the terpenes and the nitrogen-containing compound.

6. A rubber composition for a tire comprising:
a rubber component,
rosins and/or terpenes, and
at least one kind of nitrogen-containing compound selected from the group consisting of a nitrogen-containing heterocyclic compound, a tertiary amine compound, and an amino alcohol.

7. The rubber composition for a tire according to claim 6, wherein
a total amount of the rosins and/or the terpenes and the nitrogen-containing compound is 5 parts by mass or more and 25 parts by mass or less with respect to 100 parts by mass of the rubber component.
